(19) United States
(12) Patent Application Publication
(10) Pub. No.: US 2014/0023313 A1
(43) Pub. Date: Jan. 23, 2014

(54) HYBRID INTEGRATED OPTICAL DEVICE AND FABRICATION METHOD THEREOF

(71) Applicant: Electronics and Telecommunications Research Institute, (US)

(72) Inventors: Hyun Soo KIM, Daejeon (KR); Mi-Ran Park, Daejeon (KR); Jong Sool Jeong, Daejeon (KR); Byungseok Choi, Daejeon (KR); O-Kyun Kwon, Daejeon (KR)

(73) Assignee: Electronics and Telecommunications Research Institute, Daejeon (KR)

(21) Appl. No.: 13/795,654

(22) Filed: Mar. 12, 2013

(30) Foreign Application Priority Data
Jul. 17, 2012 (KR) 10-2012-0077728

(51) Int. Cl. G02B 6/12; G02B 6/136

(52) U.S. Cl. CPC G02B 6/12; G02B 6/136
USPC 385/14; 438/27

(57) ABSTRACT

Disclosed are a hybrid integrated optical device capable of more easily implementing impedance matching of a transmission line by using a polymer material on which a low-temperature process may be performed when an optical waveguide platform is fabricated, and a fabrication method thereof. The hybrid integrated optical device according to an exemplary embodiment of the present disclosure includes: a substrate divided into a waveguide region and a line region; a lower clad layer formed of silica and formed on the substrate; a transmission line part formed on the lower clad layer of the line region; and a height adjustment layer, a core layer, and an upper clad layer formed of a polymer and sequentially formed on the lower clad layer of the waveguide region, in which an optical waveguide is formed on the core layer.

### CROSS-REFERENCE TO RELATED APPLICATIONS

This application is based on and claims priority from Korean Patent Application No. 10-2012-0077728, filed on Jul. 17, 2012, with the Korean Intellectual Property Office, the disclosure of which is incorporated herein in its entirety by reference.

### TECHNICAL FIELD

The present disclosure relates to a hybrid integrated optical device using a planar lightwave circuit (PLC), and a fabrication method thereof.

### BACKGROUND

As high-speed Internet and various multimedia services have been recently popularized, researches on an optical communication system by a wavelength division multiplexing (WDM) method for transmitting mass information have been actively conducted. In the WDM optical communication system, in order to process optical signals of several channels having different wavelengths by a reception terminal and a transmission terminal, a technology of integrating and implementing several optical waveguides corresponding to the respective channels in parallel with low costs is essential.

For the implementation of the optical communication system with low costs, it is important to integrate an active optical device and an arrayed waveguide grating (AWG), such as an optical transmission device, a photodiode, and an optical amplifier, and an optical waveguide device, such as an arrayed variable optical attenuator (VOA). The optical integration technology is divided into a monolithic integration technology of integrating an active optical device and an optical waveguide with an optical semiconductor that is a single material, and a planar lightwave circuit hybrid integration technology of integrating active optical devices into heterogeneous planar lightwave circuit (PLC) platform by using flip chip bonding.

The monolithic integration technology has many limitations for implementing a low-price integrated optical device due to problems of optimization, reproducibility, and yield of each optical device. In the meantime, in the planar lightwave circuit hybrid integration technology, since the respective optimized active optical devices and optical waveguide devices are hybrid integrated, it is possible to achieve high yield and low-price implementation of an integrated optical device.

For large-capacity communication, such as VOD and cloud services, a high-rate optical modulation system having a modulation rate of each channel equal to or higher than a level of 10 Gbps is demanded. Accordingly, a PLC-based hybrid integration technology in the related art is focused on low-loss optical integration of the active optical device and a PLC optical waveguide, but importance of a large-capacity high-rate modulation technology having a rate of 10 Gbps or higher for each channel has been further increased recently.

FIGS. 1A and 1B are diagrams illustrating an example of a hybrid integrated optical device in the related art. FIG. 1A is a three-dimensional diagram, and FIG. 1B is a cross-sectional diagram taken along line A-A′ of FIG. 1A.

A process of fabricating the hybrid integrated optical device in the related art will be described based on FIGS. 1A and 1B. First, a terrace region T is formed by etching a silicon substrate 101, and a lower clad layer 103 and a core layer 105 formed of silica are deposited. Next, an optical waveguide W is formed through photolithography and dry etching processes, and an upper clad layer 107 formed of silica is deposited. The silica layer may generally be deposited at a high temperature of 1,000° C. or higher by a flame hydrolysis deposition method, or is deposited at a low temperature and then annealed at a high temperature of 1,000° C. or higher. Next, in order to mount an active optical device PL1, a trench is formed by etching a part of the upper clad layer 107, the core layer 105, and the lower clad layer 103, a transmission line 109 and an alignment mark 113 for a flip chip are formed on an upper portion of the etched trench, and a solder 111 is formed on the transmission line 109. In this case, the transmission line 109 is a metal wiring formed of Cr/Ni/Au, NiCr/Ni/Au, Ti/Ni/Au, Ni/Au, Ti/Pt/Au, and the like, and the solder 111 may be formed of a metal or a metal compound having a low melting point, such as AuSn and In.

The active optical device PL1 including a lower clad layer 117, a core layer 119, and an upper clad layer 121 is mounted on the platform formed as described above, and in this case, it is very important to match the heights of the two core layers 105 and 119 to each other. Accordingly, it is necessary to consider a step well when the silicon terrace T is formed, and it is important to precisely adjust and etch a depth D of the silica layer in order to reduce an optical loss between the waveguides. In terms of a depth of a generally used silica layer, a depth of the lower clad layer 103 is approximately 10 to 30 μm, a depth of the core layer 105 is approximately 4 to 8 μm, and a depth of the upper clad layer 107 is approximately 10 to 20 μm. In terms of a thickness of the active optical device PL1 based on InP, a thickness of the lower clad layer 117 is approximately 2 to 4 μm and a thickness of the core layer 119 is approximately 0.2 to 1 μm in general, so that a required etching depth is approximately 16 to 30 μm. In this case, in order to precisely control the etching depth, it is advantageous to have a low etching rate. However, since the required etching depth is large, a certain degree of high etching rate is inevitable considering productivity.

When the silicon terrace T is used as illustrated in FIGS. 1A and 1B, an etching rate difference (selectivity) between silica and silicon is present, and thus it is possible to precisely adjust the etching to a certain degree. When only a thin oxide layer is present on the terrace T, an electrical electric wave loss due to the silicon substrate 101 is very large, so that a high-speed operation is difficult. Accordingly, the transmission line 109 needs to be formed on a dielectric having very low conductivity or an insulator, and a possibility in that distortion is generated when a photolithography process for forming the flip chip alignment mark is performed is increased due to the high etching step D.

FIG. 2 is a diagram illustrating another example of a hybrid integrated optical device in the related art.

In the example of FIG. 2, a lower clad layer 203 formed of silica and having a thickness of 15 μm or more is deposited on a silicon substrate 201, and a silica core layer 205 is formed. Next, an optical waveguide is formed through a photolithography process and an etching process, and an upper clad layer 207 formed of silica is deposited. Next, a silica terrace T is formed by etching a part of the upper clad layer 207, the core layer 205, and the lower clad layer 203 in order to mount an active optical device PL1, and a transmission line 209, a solder 211, and an alignment mark (not illustrated) for a flip chip are formed on the terrace T.

In comparison between FIGS. 1A and 1B and FIG. 2, it is possible to decrease a waveguide loss of the transmission line 209 by the silicon substrate 201 by using the silica terrace T to improve a high-speed operation characteristic, but it is difficult to form the transmission line 209 having accurate impedance due to a large etching depth D′ of approximately 16 to 30 μm. For the high-speed operation, an impedance matching resistor formed of a thin film, such as TaN, may be formed on the optical waveguide platform together with the transmission line 209 (in this case, the impedance matching resistor, such as TaN, is determined by a width of the thin film in given sheet resistance), and in the case of a platform having a large etching step, it is difficult to accurately adjust a pattern width, so that it is difficult to form thin film-type matching resistor having an accurate resistance value.

### SUMMARY

The present disclosure has been made in an effort to provide a hybrid integrated optical device capable of more easily implementing impedance matching of a transmission line by using a polymer material on which a low-temperature process may be performed when an optical waveguide platform is fabricated, and a fabrication method thereof.

An exemplary embodiment of the present disclosure provides a hybrid integrated optical device, including: a substrate divided into a waveguide region and a line region; a lower clad layer formed of silica and formed on the substrate; a transmission line part formed on the lower clad layer of the line region; and a height adjustment layer, a core layer, and an upper clad layer formed of a polymer and sequentially formed on the lower clad layer of the waveguide region, in which an optical waveguide is formed on the core layer. The hybrid integrated optical device may further include an active optical device mounted on the transmission line part, and a core layer of the active optical device and the core layer of the waveguide region may be positioned on the same line.

The transmission line part may include an impedance matching resistor, a transmission line including a signal line and a ground line, a solder for mounting an active optical device, and a flip chip alignment mark.

Another exemplary embodiment of the present disclosure provides a hybrid integrated optical device, including: a substrate divided into a first line region including a waveguide region, and a second line region; a lower clad layer formed of silica and formed on the substrate; first and second transmission line parts formed on the lower clad layers of the first and second line regions, respectively; and a height adjustment layer, a core layer, and an upper clad layer formed of a polymer and sequentially formed on the first transmission line part of the waveguide region, in which an optical waveguide is formed on the core layer. The hybrid integrated optical device may further include first and second active optical devices serially mounted on the first and second transmission line parts, respectively, and core layers of the first and second active optical devices and the core layer of the waveguide region may be positioned on the same line.

Yet another exemplary embodiment of the present disclosure provides a method of fabricating hybrid integrated optical device, including; forming a lower clad layer formed of silica on a substrate divided into a waveguide region and a line region; forming a transmission line part on the lower clad layer of the line region; forming a height adjustment layer and a core layer formed of a polymer material on the lower clad layer on which the transmission line part is formed; forming an optical waveguide by etching a part of the core layer of the waveguide region; forming an upper clad layer formed of a polymer material on the core layer; and etching the upper clad layer, the core layer, and the height adjustment layer of the line region so that the transmission line part is exposed.

Still yet another exemplary embodiment of the present disclosure provides a method of fabricating hybrid integrated optical device, including; forming a lower clad layer formed of silica on a substrate divided into a first line region including a waveguide region, and a second line region; forming first and second transmission line parts on the lower clad layers of the first and second line regions, respectively; forming a height adjustment layer and a core layer formed of a polymer material on the lower clad layers on which the first and second transmission line parts are formed; forming an optical waveguide by etching a part of the core layer of the waveguide region; forming an upper clad layer formed of a polymer on the core layer; and etching the upper clad layer, the core layer, and the height adjustment layer of the first and second line regions except for the waveguide region so that the first and second transmission line parts are exposed. The method may further include etching an upper portion of the lower clad layer of the second line region by a predetermined depth after the forming of the lower clad layer.

The height adjustment layer, the core layer, and the upper clad layer may be formed by a low-temperature polymer deposition process including a spin coating method.

According to the exemplary embodiments of the present disclosure, it is possible to easily form a transmission line having an accurate impedance matching resistor by forming a transmission line part on a lower clad layer formed of silica and then forming an optical waveguide through a low-temperature polymer deposition process and an etching process.

According to the exemplary embodiments of the present disclosure, it is possible to accurately adjust an etching depth by using high etching selectivity between silica and polymer when etching a deep trench in which an active optical device is to be mounted.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A and 1B are diagrams illustrating an example of a hybrid integrated optical device in the related art.

FIG. 2 is a diagram illustrating another example of a hybrid integrated optical device in the related art.

FIG. 3 is a diagram illustrating a hybrid integrated optical device according to an exemplary embodiment of the present disclosure.

FIGS. 4A to 4D are diagrams for describing a method of fabricating the hybrid integrated optical device according to the exemplary embodiment (FIG. 3) of the present disclosure.

FIG. 5 is a diagram illustrating a hybrid integrated optical device according to another exemplary embodiment of the present disclosure.

FIG. 6 is a diagram illustrating a hybrid integrated optical device according to yet another exemplary embodiment of the present disclosure.

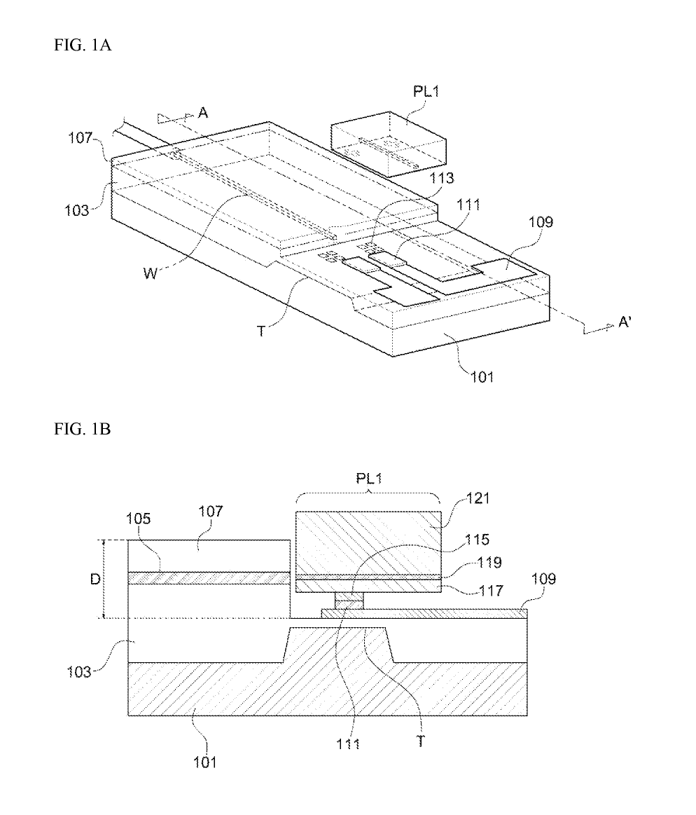

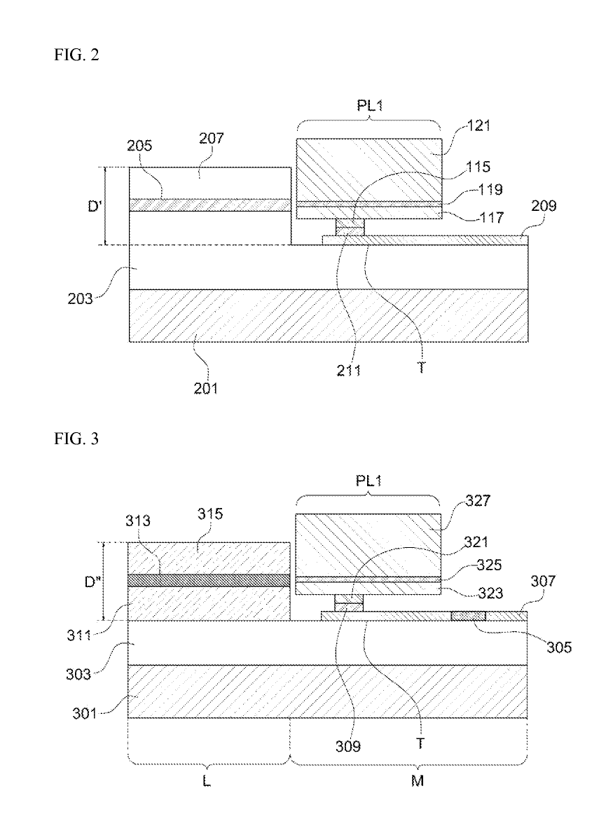

### DETAILED DESCRIPTION

In the following detailed description, reference is made to the accompanying drawing, which form a part hereof. The illustrative embodiments described in the detailed description, and drawings are not meant to be limiting. Other embodiments may be utilized, and other changes may be made, without departing from the scope of the invention.

FIG. 3 is a diagram illustrating a hybrid integrated optical device according to an exemplary embodiment of the present disclosure.

Referring to FIG. 3, the hybrid integrated optical device according to the exemplary embodiment of the present disclosure includes a substrate 301 divided into a waveguide region L and a line region M, a lower clad layer 303 formed of silica and formed on the substrate 301, a transmission line part formed on the lower clad layer 303 of the line region M, and a height adjustment layer 311, a core layer 313, and an upper clad layer 315 formed of a polymer material and sequentially formed on the lower clad layer 303 of the waveguide region L.

The transmission line part includes an impedance matching resistor 305, a transmission line 307 including a signal line and a ground line, and a solder 309 for mounting an active optical device PL1, and may further include a flip chip alignment mark (not illustrated). The impedance matching resistor may be a resistance chip or a thin film resistor, such as TaN. The transmission line 307 may be implemented in a type of a coplanar waveguide (CPW) or a microstrip, which is a widely known technology, so that a detailed description thereof will be omitted.

The active optical device PL1 including a lower clad layer 323, a core layer 325, and an upper clad layer 327 may be mounted on the transmission line part. In this case, the active optical device PL1 may be mounted so that the core layer 313 of the waveguide region L and the core layer 325 of the active optical device PL1 are positioned on the same line.

The active optical device PL1 may be one of a photodiode, an optical modulator, an optical amplifier, an optical attenuator, and an optical transmitter, and may be a single device or an integrated device in which several unit devices are integrated.

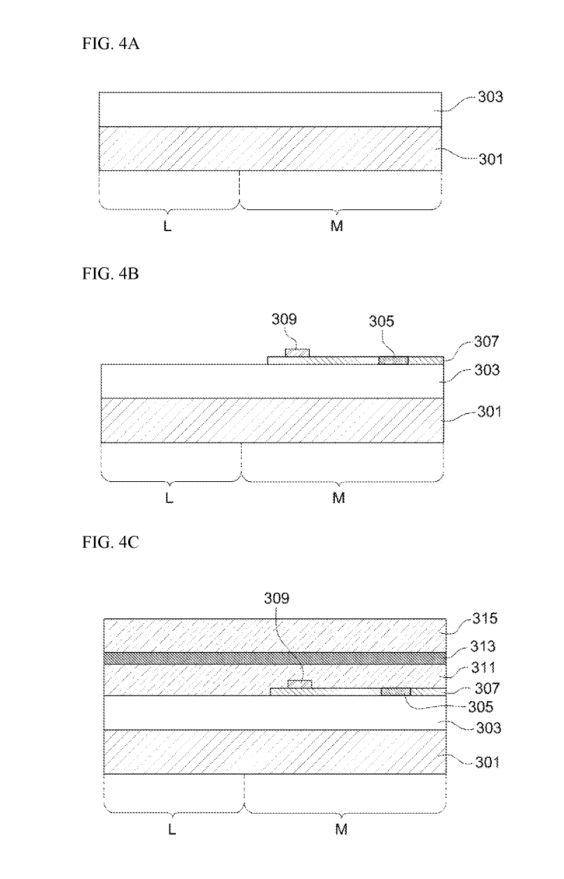

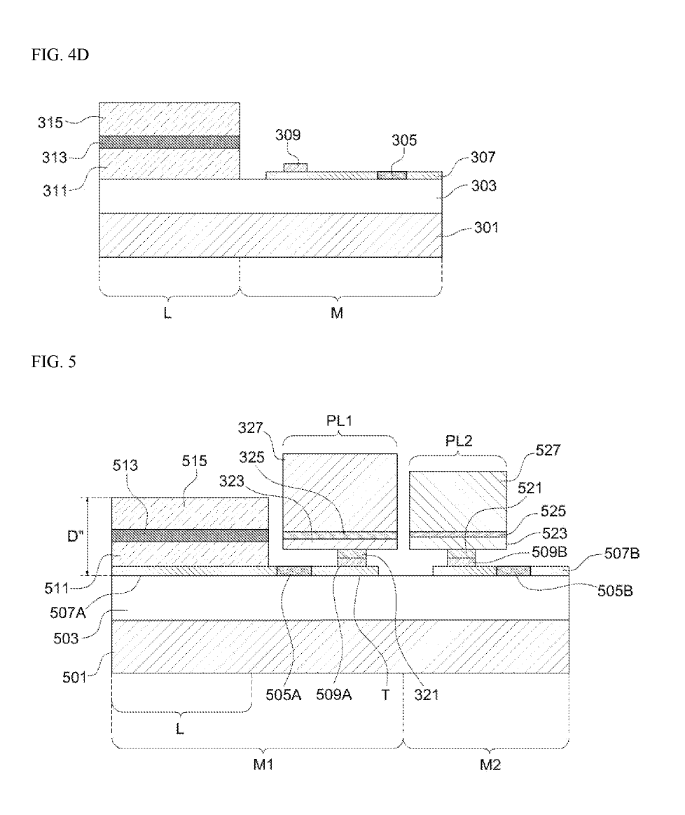

FIGS. 4A to 4D are diagrams for describing a method of fabricating the hybrid integrated optical device according to the exemplary embodiment (FIG. 3) of the present disclosure.

First, as illustrated in FIG. 4A, the lower clad layer 303 formed of silica is formed on the substrate 301 divided into the waveguide region L and the line region M. In this case, a thickness of the lower clad layer 303 may be 15 μm or more.

Next, as illustrated in FIG. 4B, the transmission line part including the impedance matching resistor 305, the transmission line 307, and the solder 309 is formed on the lower clad layer 303 of the line region M. In this case, the alignment mark for the flip chip (not illustrated) may be further formed together with the transmission line 307. The transmission line part formed of a metal or a metal compound has higher adhesion for an inorganic material, such as silica, than that for an organic material, such as polymer. Since it is necessary to perform a high-temperature heat treatment at 350° C. or higher after the deposition of the transmission line, the lower clad layer 303 may be formed of silica maintaining a stable state even at a high temperature.

Subsequently, as illustrated in FIG. 4C, the height adjustment layer 311 and the core layer 313 formed of a polymer material are formed on the lower clad layer 303 on which the transmission line part is formed, an optical waveguide is formed on the core layer 313 through a photolithography process and an etching process, and then the upper clad layer 315 formed of a polymer material is formed. A low-temperature process, such as a spin coating method, may be used for deposition of the polymer layers 311, 313, and 315.

Next, as illustrated in FIG. 4D, the upper clad layer 315, the core layer 313, and the height adjustment layer 311 on the line region M are etched so that the lower clad layer 303 and the transmission line part are exposed. In this case, the lower clad layer 303 formed of the silica material may serve as an etching stopping layer. That is, in the present exemplary embodiment, the transmission line part is not formed after etching the silica layer like the related art, but the transmission line parts are all formed on the lower clad layer 303 formed of the silica material and then the optical waveguide is formed through a low-temperature polymer deposition process and an etching process.

As described above, since the thin film-type impedance matching resistor 305 and the transmission line 307 are directly formed on a plane after the deposition of the lower clad layer 303, it is very easy to implement accurate impedance matching, and since the flip chip alignment mark is also formed on the plane, a distortion phenomenon that may occur in the photolithography process may be prevented when the large step is present. Since the lower clad layer 303 is formed of an inorganic material, such as silica, and the height adjustment layer 311, the core layer 313, and the upper clad layer 315 are formed of an organic material, such as polymer, the lower clad layer 303 serves as an etching stopping layer by high etching selectivity between silica and polymer in the etching step of FIG. 4D, and thus an etching step D″ may be accurately adjusted.

FIG. 5 is a diagram illustrating a hybrid integrated optical device according to another exemplary embodiment of the present disclosure.

Referring to FIG. 5, the hybrid integrated optical device according to another exemplary embodiment of the present disclosure includes a substrate 501 divided into a first line region M1 including a waveguide region L and a second line region M2, a lower clad layer 503 formed of silica and formed on the substrate 501, first and second transmission line parts formed on the lower clad layers 503 of the first and second line regions M1 and M2, respectively, and a height adjustment layer 511, a core layer 513, and an upper clad layer 515 formed of a polymer material and sequentially formed on the first transmission line part of the waveguide region L.

The first and second transmission line parts include impedance matching resistors 505A and 505B, transmission lines 507A and 507B, and solders 509A and 509B, respectively. First and second active optical devices PL1 and PL2 are serially mounted on the first and second transmission line parts, and in this case, core layers 325 and 525 of the first and second active optical devices PL1 and PL2 and the core layer 513 of the waveguide region L need to be positioned on the same line. The particular characteristic, a fabrication method, and a resultant effect are the same as those described through the exemplary embodiments of FIGS. 3, and 4A to 4D.

In the case of the related art, when the first and second active optical devices PL1 and PL2 are serially mounted on the optical waveguide platform as illustrated in FIG. 5, it is difficult to form all of the transmission lines in one direction. Especially, when the transmission lines are formed only in one direction in a case where the plurality of active optical devices is mounted even in series and in parallel, there occurs a spatial limitation, such as generation of crosstalk between the transmission lines. In order to remove the crosstalk, the transmission lines need to be disposed so as to have a sufficient space, but in this case, it is difficult to achieve a low priced and small optical device. In the meantime, in the present disclosure, the transmission lines 507A and 507B may be formed under the height adjustment layer 511 and the core layer 513, so that it is possible to achieve microminiaturization of the device while removing the crosstalk between the transmission lines.

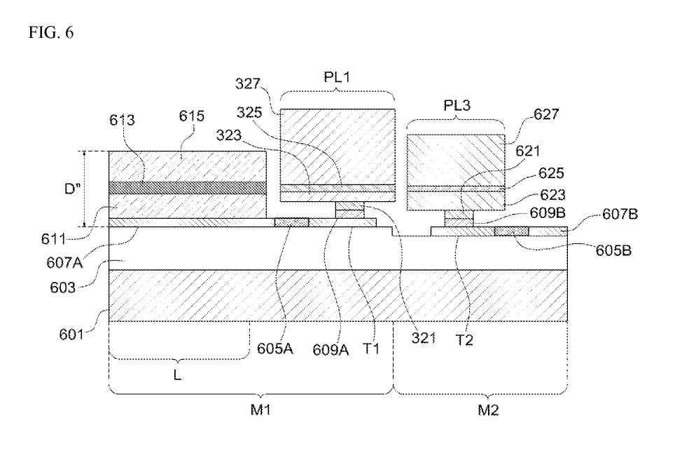

FIG. 6 is a diagram illustrating a hybrid integrated optical device according to yet another exemplary embodiment of the present disclosure, and illustrates a case where two active optical devices PL1 and PL3 in which positions of core layers 325 and 625 are different from each other are serially mounted.

In general, in the case of the different active optical devices, a thickness of the core layer is different from a thickness of the clad layer within each device in order to exhibit an optimum operation state. Accordingly, as illustrated in FIG. 6, in order to serially connect the different active optical devices PL1 and PL3 with a minimum optical loss, it is important to match the heights of the two core layers 325 and 625 to each other to dispose the two core layers 325 and 625 on the same line.

To this end, in the exemplary embodiment of FIG. 6, a lower clad layer 603 formed of silica is deposited on a substrate 601 divided into a first line region M1 and a second line region M2, and then a first terrace T1 and a second terrace T2 are formed by finely etching an upper end of the lower clad layer 603 of the second line region M2. In this case, thicknesses of lower clad layers 323 and 623 of the active optical devices PL1 and PL3 are approximately 2 to 4 μm and thicknesses of the core layers 325 and 625 are approximately 0.2 to 1 μm in general, so that a step between the first and second terraces T1 and T2 has a small value within 3 μm. Accordingly, subsequent formation of impedance matching resistors 605A and 605B and transmission lines 607A and 607B are not significantly influenced.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A hybrid integrated optical device, comprising:
a substrate divided into a waveguide region and a line region;
a lower clad layer formed of silica material and formed on the substrate;
a transmission line part formed on the lower clad layer of the line region; and
a height adjustment layer, a core layer, and an upper clad layer formed of a polymer and sequentially formed on the lower clad layer of the waveguide region,
wherein an optical waveguide is formed on the core layer.

2. The hybrid integrated optical device of claim 1, wherein the transmission line part comprises an impedance matching resistor, a transmission line including a signal line and a ground line, a solder for mounting an active optical device, and a flip chip alignment mark.

3. The hybrid integrated optical device of claim 2, wherein the transmission line is a coplanar waveguide (CPW) type or a microstip type.

4. The hybrid integrated optical device of claim 1, further comprising:
an active optical device mounted on the transmission line part,
wherein a core layer of the active optical device and the core layer of the waveguide region are positioned on the same line.

5. The hybrid integrated optical device of claim 4, wherein the active optical device is a photodiode, an optical modulator, an optical amplifier, an optical attenuator, or an optical transmitter.

6. A hybrid integrated optical device, comprising:
a substrate divided into a first line region including a waveguide region, and a second line region;
a lower clad layer formed of silica and formed on the substrate;
first and second transmission line parts formed on the lower clad layers of the first and second line regions, respectively; and
a height adjustment layer, a core layer, and an upper clad layer formed of a polymer and sequentially formed on the first transmission line part of the waveguide region,
wherein an optical waveguide is formed on the core layer.

7. The hybrid integrated optical device of claim 6, wherein the first and second transmission line parts comprise an impedance matching resistor, a transmission line including a signal line and a ground line, a solder for mounting an active optical device, and a flip chip alignment mark, respectively.

8. The hybrid integrated optical device of claim 6, further comprising:
first and second active optical devices serially mounted on the first and second transmission line parts, respectively,
wherein core layers of the first and second active optical devices and the core layer of the waveguide region are positioned on the same line.

9. The hybrid integrated optical device of claim 6, wherein a height of the lower clad layer of the first line region is different from a height of the lower clad layer of the second line region.

10. A method of fabricating hybrid integrated optical device, comprising:
forming a lower clad layer formed of silica on a substrate divided into a waveguide region and a line region;
forming a transmission line part on the lower clad layer of the line region;
forming a height adjustment layer and a core layer formed of a polymer material on the lower clad layer on which the transmission line part is formed;
forming an optical waveguide by etching a part of the core layer of the waveguide region;
forming an upper clad layer formed of a polymer material on the core layer; and
etching the upper clad layer, the core layer, and the height adjustment layer of the line region so that the transmission line part is exposed.

11. The method of claim 10, wherein the height adjustment layer, the core layer, and the upper clad layer are formed by a low-temperature polymer deposition process including a spin coating method.

12. The method of claim 10, wherein the transmission line part comprises an impedance matching resistor, a transmission line including a signal line and a ground line, a solder for mounting an active optical device, and a flip chip alignment mark.

13. The method of claim 10, further comprising:
mounting an active optical device on the exposed transmission line part so that a core layer of the active optical device and the core layer of the waveguide region are positioned on the same line.

14. A method of fabricating hybrid integrated optical device, comprising:
forming a lower clad layer formed of silica on a substrate divided into a first line region including a waveguide region and a second line region;
forming first and second transmission line parts on the lower clad layers of the first and second line regions, respectively;
forming a height adjustment layer and a core layer formed of a polymer material on the lower clad layers on which the first and second transmission line parts are formed;
forming an optical waveguide by etching a part of the core layer of the waveguide region;
forming an upper clad layer formed of a polymer material on the core layer; and
etching the upper clad layer, the core layer, and the height adjustment layer of the first and second line regions except for the waveguide region so that the first and second transmission line parts are exposed.

15. The method of claim 14, wherein the height adjustment layer, the core layer, and the upper clad layer are formed by a low-temperature polymer deposition process including a spin coating method.

16. The method of claim 14, further comprising:
etching an upper portion of the lower clad layer of the second line region by a predetermined depth after the forming of the lower clad layer.

17. The method of claim 14, further comprising:
serially mounting first and second active optical devices on the exposed first and second transmission line parts so that core layers of the first and second active optical devices and the core layer of the waveguide region are positioned on the same line.
